(19) United States
(12) Patent Application Publication
(10) Pub. No.: US 2021/0203213 A1
(43) Pub. Date: Jul. 1, 2021

(54) STRUCTURES AND METHODS OF MANUFACTURE OF SERPENTINE STATOR COILS

(71) Applicant: Core Innovation, LLC, Ronan, MT (US)

(72) Inventors: Matthew Benart JORE, Ronan, MT (US); Michael Alan KVAM, Polson, MT (US); James Douglas JORE, Polson, MT (US); James David DUFORD, Polson, MT (US)

(21) Appl. No.: 16/761,863

(22) PCT Filed: Apr. 20, 2018
(86) PCT No.: PCT/US2018/028474

§ 371 Date: May 6, 2020

Related U.S. Application Data
(60) Provisional application No. 62/581,808, filed on Nov. 6, 2017.

(51) Int. Cl. H02K 15/02; H02K 3/28; H02K 15/00; H02K 15/04

(52) U.S. Cl. CPC H02K 15/024; H02K 3/28; H02K 15/0062; H02K 15/0407; H02K 15/0478; H02K 15/0068

(57) ABSTRACT

Methods of winding a serpentine pattern of a stator coil and structures made from the methods. In one embodiment, a method forms a serpentine winding from a bundle of wires with a first end and a second end, then joins a first group of in-hand conductors of the second end to a second group of in-hand conductors of the first end, the result of which electrically connects a first turn to a second turn. The successive turns of the coil are connected in the same manner. In one embodiment, a method forms a multiple phase serpentine winding, such as three-phases, with coplanar radial conductors. In one embodiment, a method includes a method of forming a serpentine winding on one or more layers of a printed circuit board (PCB). In one embodiment, a method uses plated slots adjacent one or more radial torque inducing conductors to electrically connect the radial conductors of one layer to one or more corresponding radially torque inducing conductor(s) on at least one other layer. In one embodiment, a method removes the electrically conductive material on at least one end of the plated slot in order to reduce looping electrical currents. In one embodiment, a method removes the electrically conductive material from each end of a plated slot so that a pair of radially torque inducing conductors are electrically connected in series.

### CROSS REFERENCE TO RELATED APPLICATION

This application claims the benefit of U.S. Provisional Application No. 62/581,808 filed Nov. 6, 2017, which is hereby incorporated by reference in its entirety.

### TECHNICAL FIELD

The present invention is generally related to structures and methods of manufacture of stators and, in particular, providing for connections of parallel and series conductors of stators for use in motors and generators, and more specifically to serpentine wound stators.

### BACKGROUND

Presently, fabrication of serpentine wound windings for stators of motors and generators involves using a single conductor and repeatedly winding a serpentine coil pattern to attain the desired number of turns. Although such a technique has proven to be reliable over a long history, it also is a fairly inefficient process. Hence, there is a need to enable a simple and effective manufacturing method for serpentine wound stators.

### SUMMARY OF THE INVENTION

Methods of winding a serpentine pattern of a stator coil and structures made from the methods.

These and other aspects of the invention will be apparent from and elucidated with reference to the embodiment(s) described hereinafter.

### BRIEF DESCRIPTION OF THE DRAWINGS

Many aspects of certain embodiments of the invention can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a schematic diagram showing a view of eighteen in-hand, cut to length conductors, which in-hand conductors have a first end and a second end.

FIG. 2 is a schematic diagram showing a view of eighteen in-hand, cut to length conductors, which in-hand conductors have a first end and a second end and which in-hand conductors are periodically bound together into a bundle.

FIG. 3 is a schematic diagram showing a view of in-hand conductors formed into a serpentine-patterned wound stator coil, which in-hand conductors have a first end and a second end.

FIG. 4 is a schematic diagram showing a view of in-hand conductors formed into a serpentine-patterned wound stator coil with first ends of an in-hand conductor connected to second ends of another in-hand conductor so as to form a series circuit of the in-hand conductors.

FIG. 5 is a schematic diagram showing a more detailed view of a portion of FIG. 4 illustrating an embodiment of the connections of the first ends of the in-hand conductors to the second ends of another in-hand conductor so as to form a series circuit of the in-hand conductors.

FIG. 6 is a schematic diagram showing an illustration of three phases of in-hand, serpentine-patterned wound stator coils arrayed as a six-terminal stator.

FIG. 7 is a schematic diagram showing an illustration of a single phase of serpentine-patterned wound stator coil formed so as to provide for coplanar configuration of multiple phases.

FIG. 8 is a schematic diagram showing a more detailed perspective view of a portion of FIG. 6 showing the coplanar configuration of the radial, torque inducing conductors of an axial gap stator and of the connections of the first ends of the in-hand conductors to the second ends of another in-hand conductor so as to form a series circuit of the in-hand conductors.

FIG. 9 is a schematic diagram showing an illustration of layer one of an axial stator formed of a stack of fourteen conductor layers of printed circuit boards (PCBs).

FIG. 10 is a schematic diagram showing an illustration of layers 2, 3, 4 and 5 which form power layers of a first phase of a three phase, axial stator of a stack of fourteen layers of PCBs.

FIG. 11 is a schematic diagram showing an illustration of layers 6, 7, 8 and 9 which form power layers of a second phase of a three phase, axial stator of a stack of fourteen layers of PCBs.

FIG. 12 is a schematic diagram showing an illustration of layers 10, 11, 12 and 13 which form power layers of a third phase of a three phase, axial stator of a stack of fourteen layers of PCBs.

FIG. 13 is a schematic diagram showing an illustration of layer fourteen of an axial stator formed of a stack of fourteen layers of PCBs.

FIG. 14A is a schematic diagram showing an axial cross sectional view of the 14 layers of parallel, radial, torque-inducing conductors of a first phase of a three phase, axial stator with conductive plating of an axial slot providing for electrical connectivity from four power layers to all the other parallel, radial, torque-inducing conductors.

FIG. 14B is a schematic diagram showing an axial cross-sectional view of the 14 layers of parallel, radial, torque-inducing conductors of a second phase of a three phase, axial stator with conductive plating of an axial slot providing for electrical connectivity from four power layers to all the other parallel, radial, torque-inducing conductors.

FIG. 14C is a schematic diagram showing an axial cross-sectional view of the 14 layers of parallel, radial, torque-inducing conductors of a third phase of a three phase, axial stator with conductive plating of an axial slot providing for electrical connectivity from four power layers to all the other parallel, radial, torque-inducing conductors.

FIG. 15A is a detail view of a portion of the PCB stator of FIG. 10 illustrating radial conductors and plated slots.

FIG. 15B is a detail view of a portion of the PCB stator of FIG. 10 illustrating radial conductors, plated slots and a circulating current path.

FIG. 15C is a detail view of a portion of the PCB stator of FIG. 10 illustrating radial conductors, plated slots and the removal of plated slot conductive material at both ends of the slot.

FIG. 16 is a schematic diagram of one layer of an embodiment of a plated slot PCB stator having all radial conductors in series.

### DETAILED DESCRIPTION OF EMBODIMENTS

Certain embodiments of a method of winding a serpentine pattern of a stator coil and corresponding structures made from the method are disclosed. In one embodiment, a method and structure involves fabricating a serpentine winding by utilizing in-hand insulated conductors to form the serpentine coil in a single winding step, instead of using a single conductor and repeatedly winding a serpentine coil pattern to attain the desired number of turns. Note that reference to in-hand or the like refers to in parallel. Certain method embodiments, as disclosed herein, wind in-hand (in parallel) insulated conductors (e.g., wires), and once the in-hand conductors are wound into the serpentine pattern, first ends are connected to a second end of conductors to form a series connection of the insulated conductors. That is, the in-hand (in-parallel) configuration is no longer parallel, but rather, a continuous series connection. In other words, certain embodiments of the disclosed method provide for manufacturing a serpentine coil stator structure according to the aforementioned physical transformation.

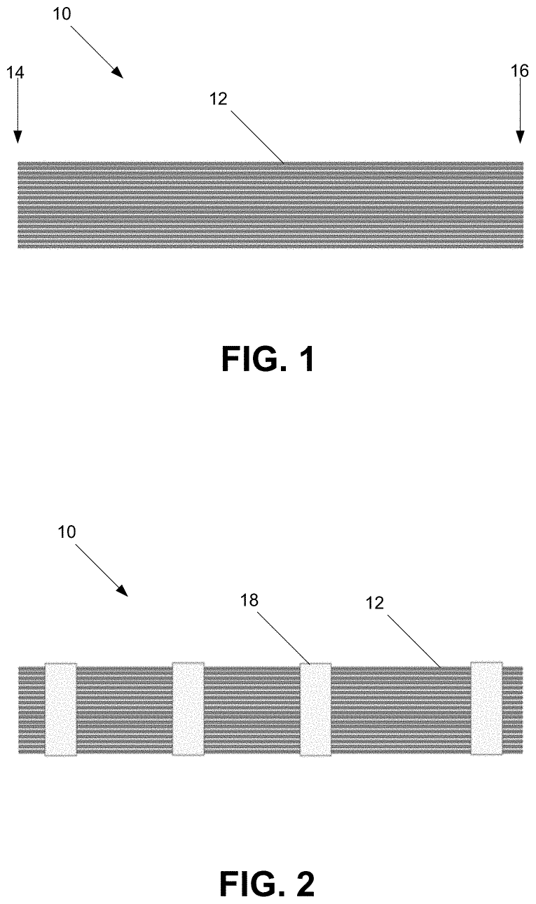

In one embodiment, and referring to FIG. 1, this method starts by preparing an in-hand bundle 10 of insulated conductors (e.g., each conductor 12) equal in count to the number of desired turns. The in-hand conductors 12 can be cut to form a first end 14 and a second end 16, with the necessary length for completion of a serpentine coil pattern and with an adequate additional amount of length provided for subsequently deriving the series connections of the first end 14 of one in-hand conductor 10 to a second end 16 of another in-hand conductor 12 so as to form turns. Alternatively, the in-hand conductors 10 can be fed from spools with the severing from the spooled conductors to form a second end, then waiting until after the serpentine coil pattern is formed before proceeding to joining the second end to a first end of another in-hand conductor to form series connections and turns of conductors. Hence, certain embodiments of a method of manufacturing involve winding of the serpentine pattern of a coil, and after the serpentine pattern is formed, joining the ends to make a series connection (e.g., selective, continuous length of series-linked conductors instead of in-hand/in-parallel conductors). There are many ways to join conductors so as to provide for series connections, including but not limited to, soldering, brazing, welding, swaging with couplers, etc.

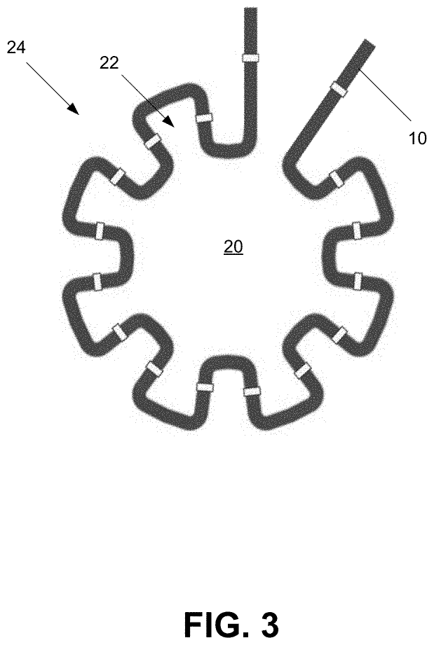

In some embodiments, the in-hand conductors 12 of the bundle 10 can be periodically or continuously bound (e.g., sheathing the bundle of conductors) so as to make a semi-rigid parallel bundle for subsequent ease of coiling. One example of such periodic binding via binders 18 is illustrated in FIG. 2. Note that the binders 18 may be of any material suitable to enable wrapping and/or self-adhesion, including tape, shrink wrap, plastic, etc.

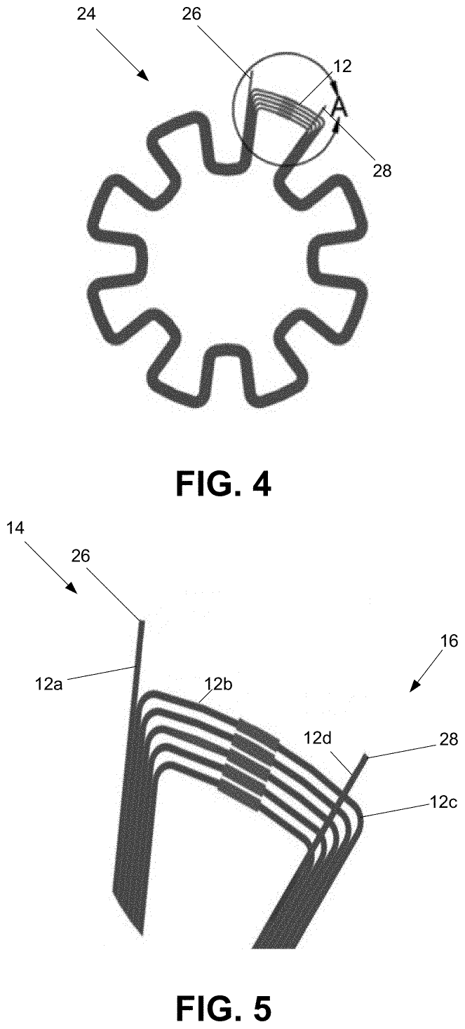

Referring now to FIG. 3, the parallel set of in-hand conductors 12 (e.g., the bundle 10) are then bent around a fixturing jig or an integral stator support 20 by following a series of outer bends 22 to form a serpentine coil pattern 24 (stator). By using this in-hand coil winding method, one avoids the complexity, when using just one continuous conductor, of having to repeatedly and sequentially form both an outer and then inner bends to make turns for a serpentine patterned coil, which inner bends are especially problematic to form because accomplishing such inner bends requires pushing the conductor for inner turn shaping, which is hard to maintain tension as pushing on a flexible conductor is a bit like pushing on a string. In other words, in certain embodiments of the disclosed method, a pulling force is used to form an outer turn, whereas one would need to push into an inner turn to shove the conductor into a bend without the disclosed method embodiments. That is, pushing is required without the method embodiments, which is difficult to achieve with flexible conductors.

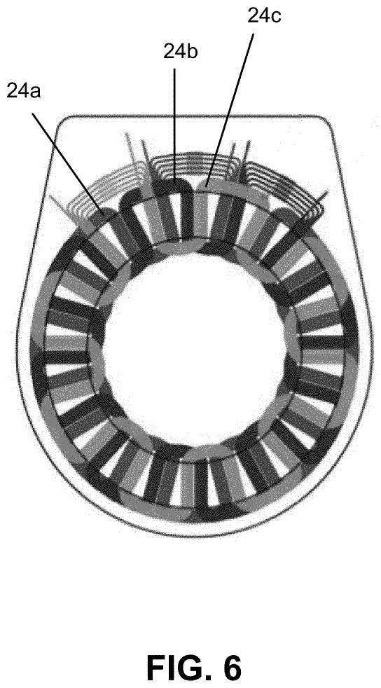

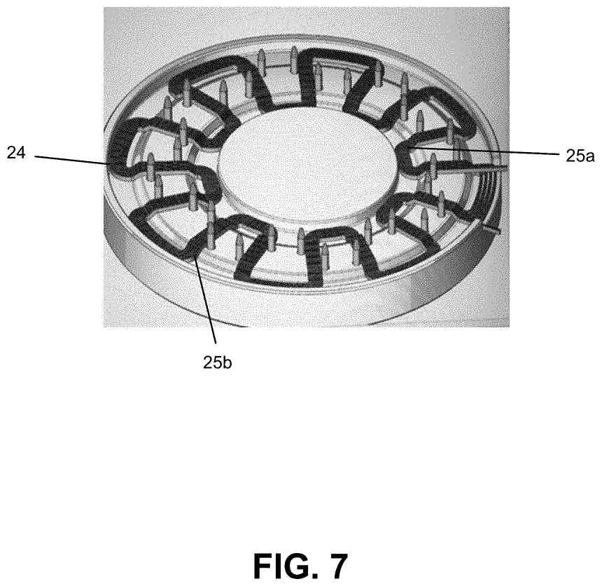

Attention is now directed to FIGS. 4-5. To form a series of turns, the ends 14,16 of the in-hand conductors 12 are selectively connected (e.g., via solder or braze sleeve) into series circuits outside of the magnetic influence zone of the stator 24. In one embodiment, an outer most conductor 12a of a first end 14 of the in-hand conductors 12 is oriented outward to lead to first polarity of an electrical terminal 26. Then, a next innermost conductor 12b of the first end 14 of the in-hand conductors 12 is taken and connected to the outer most conductor 12c of the second end 16 of the in-hand conductors 12, and then to repeat such selective inner most to outer most connection configuration until there is just remaining the inner most conductor 12d of the second end 16 which inner most conductor 12d is then lead outward and across the series connected conductors to become a second, opposite polarity of an electric terminal 28. By this means all the series connections are coplanar and only a second, opposite polarity terminal end 28 of the in-hand wound conductors 12 is non-coplanar.

Alternatively, a less preferred, and comparatively less orderly (or even random) embodiment can be made whereby series connections are made by crossing over or under of at least one of the in-hand conductors relative to an adjacent in-hand conductors to make the series connections of a first end of one in-hand conductor to a second end of another in-hand conductor, but such arrangement may invoke a non-coplanar configuration and introduce the potential for additional points of contact wear of the insulation where the conductors are crossed over and under each other to connect the ends of the in-hand wound conductors.

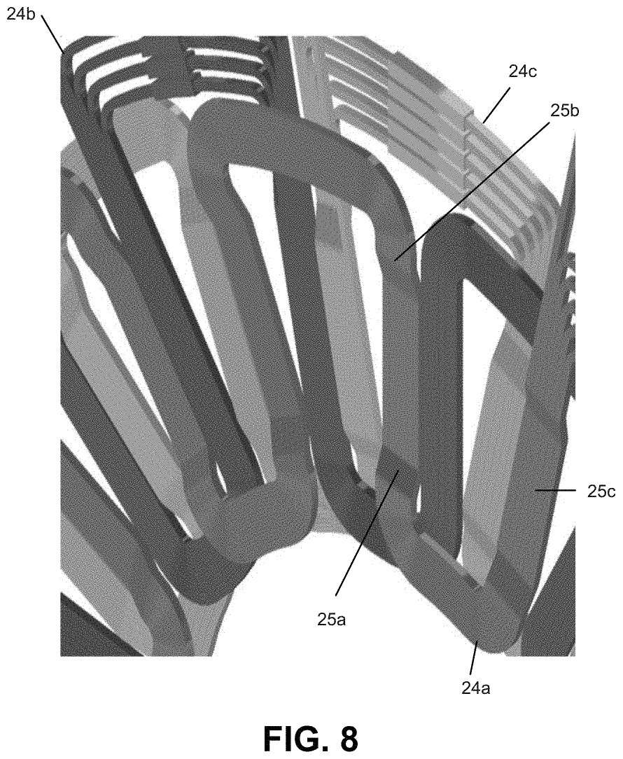

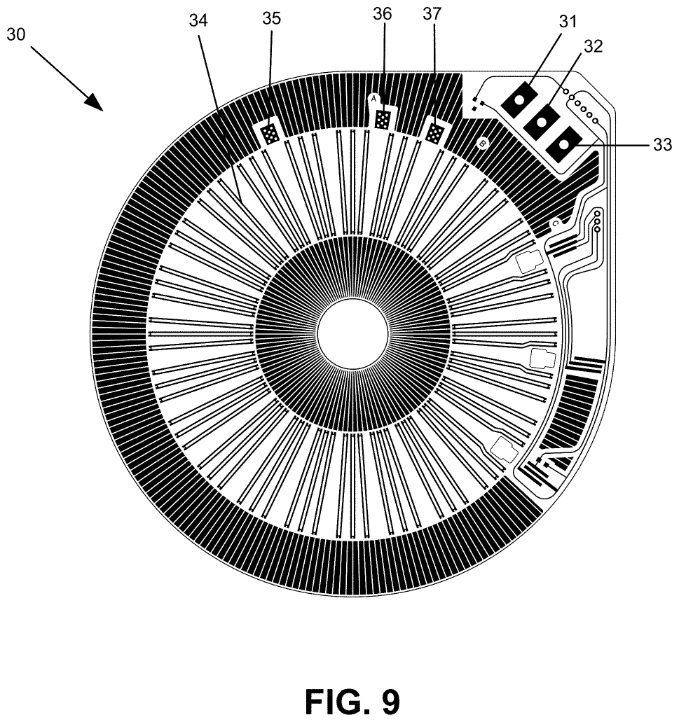

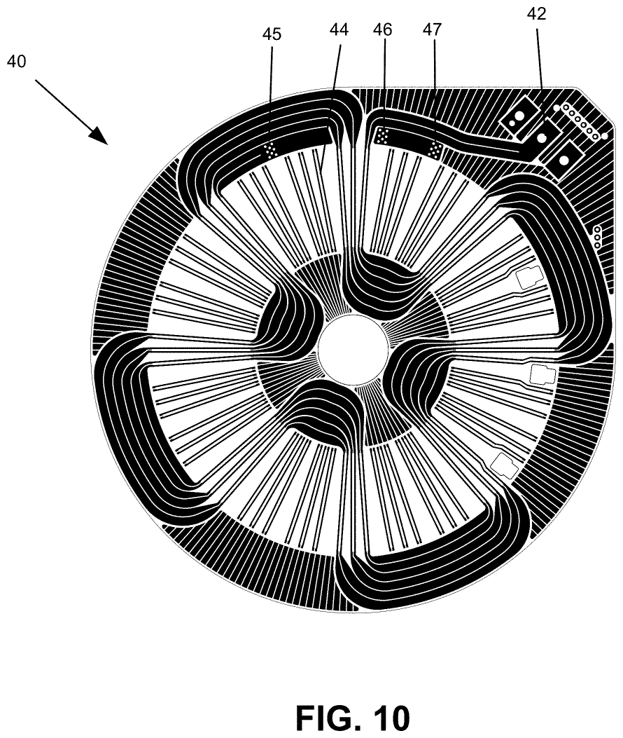

Referring now to FIG. 6, the series connected serpentine coils 24a, 24b, and 24c can be made as split phase or whole phase. Digressing briefly, a phase is associated with a timing of an alternating wave form (e.g., sinusoidal wave). A stator may have multiple phases (e.g., 3 phases, 120 degrees apart). The phase of a stator winding may be split into various length segments, instead of just one whole series. If there are two splits, then there is one half the voltage per splitting of the phase, and if there are 3 splits, then there is one third the voltage of the phase. For instance, there may be an output of 120V from two splits of a phase, or the two splits may be joined into a whole phase and derive 240V (e.g., commonly performed on job-site generators where some devices require the lower voltage and others a higher voltage). And the serpentine patterned coils 24 can be stacked in rotated electrical aligned degrees (e.g., for a three-phase machine, each phase is shifted, say, 120 degrees) to provide for multiphase stators, as illustrated in FIG. 6. The serpentine coils 24 (e.g., 24a, 24b, 24c) can be bent axially so as to provide for coplanar configuration of the multiple phases of the stators 24 to realize lesser air gap between magnetic rotors, as illustrated in FIGS. 7-8 (with FIG. 7 illustrating a single serpentine winding phase and FIG. 8 illustrating three phases comprised of three serpentine winding phases). A radial gap machine is bent radially to provide for coplanarity in the working section of the conductors. Explaining further, when viewing the radial portion of the conductors, it is noted they are coplanar in the working section of the stator (the part underneath the gap of the magnetic fields in an axial gap machine). For instance, it is noted how the end turns of the serpentine coil are axially offset to enable two different phases to cross over and under each other to enable traversal to the next radial working section. In some embodiments, the serpentine coils can be left axially unbent and simply stacked axially over and under each other in a non-coplanar configuration, in which case the air gap is inherently wider to accommodate the axial stacking of the multiple phases of serpentine coils. Said bends are depicted in FIG. 7 as 25a (on the inner radius) and 25b (on the outer radius), shown in the axial direction. In FIG. 8, said bends 25a and 25b are as shown, with the working section comprising the radial portion of the conductors and labeled as 25c.

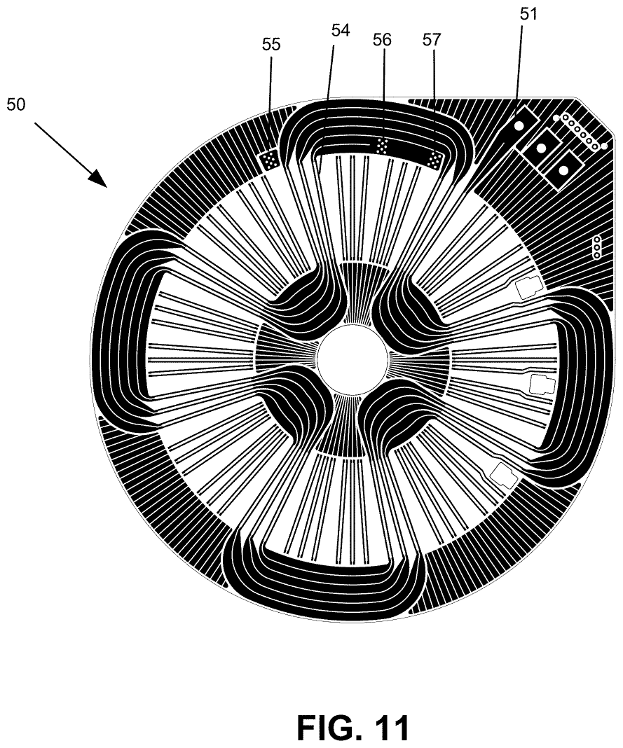

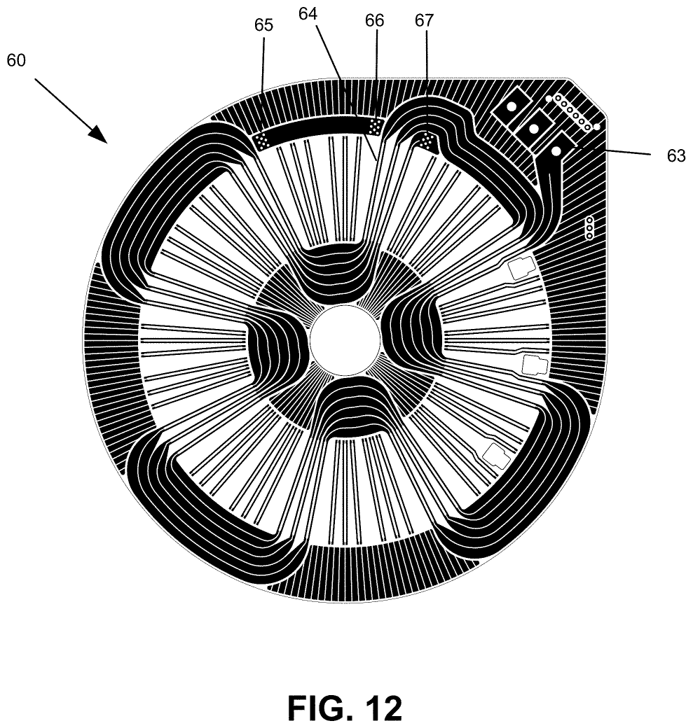

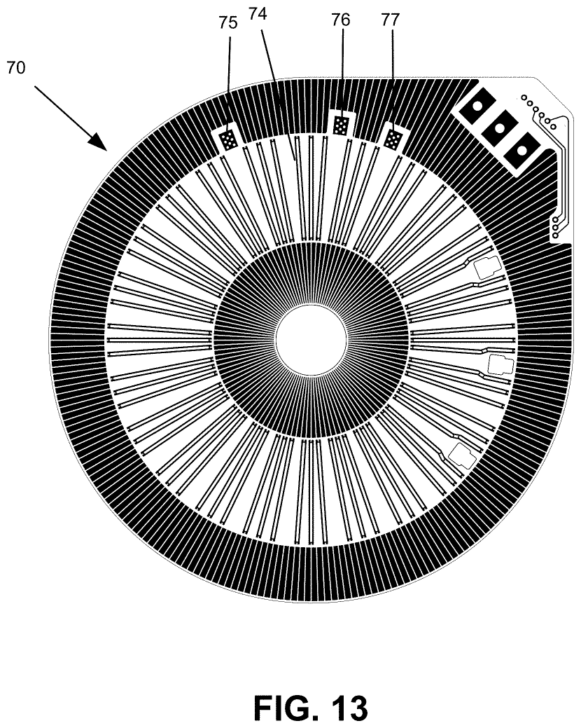

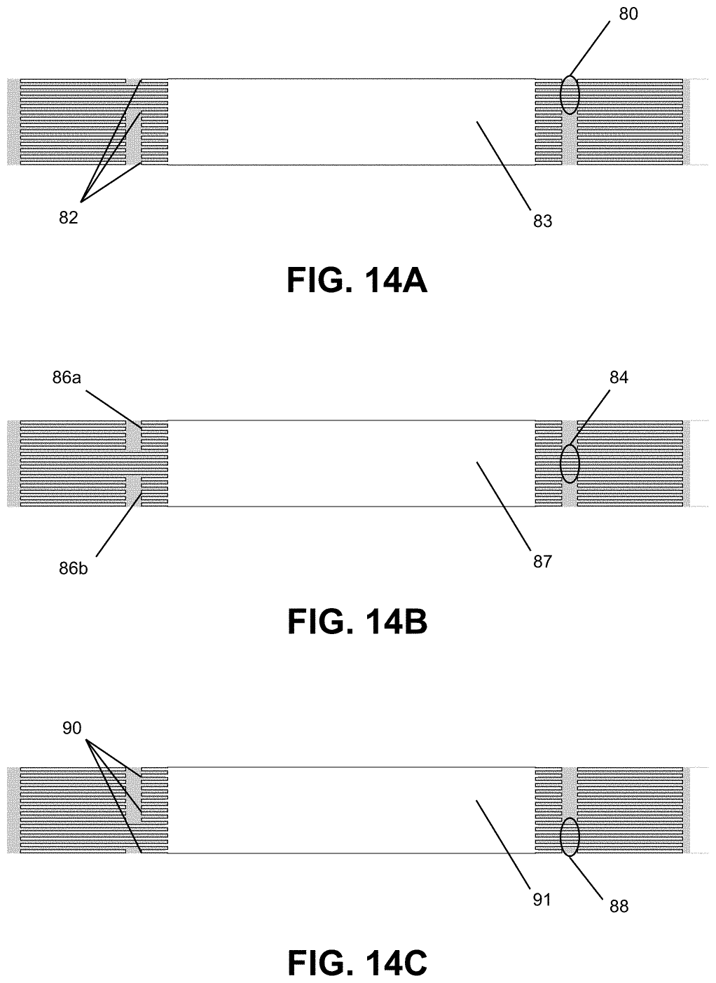

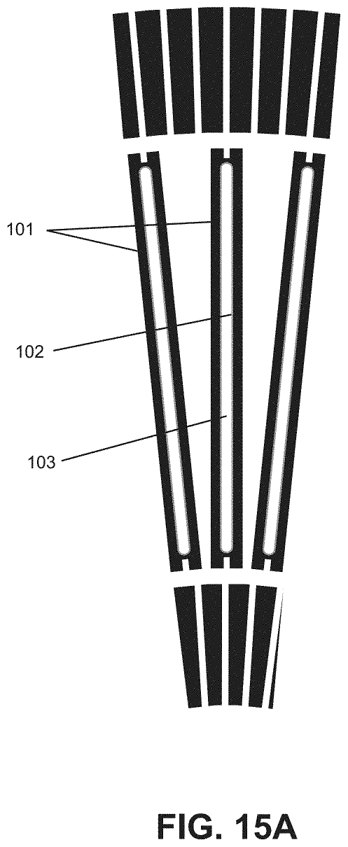

An alternative structure and method of manufacturing serpentine coils for stators is by use of printed circuit boards (PCBs). This method can be used to form split or whole phases and multiple phases, as well as multilayers of printed circuits. Additionally, there is a novel way of electrically interconnecting the axially parallel, radial torque inducing conductor sections through the axial thickness of a multilayered axial gap stator. An example embodiment of such an axial gap, PCB derived stator utilizes fourteen (14) conductor layers with three (3) turns of two in-hand conductors and eight poles, and is illustrated in FIGS. 9 to 13, whereby the dark portions are copper traces of the printed circuit (except the outer most black line and the inner most black line are respectively just the inner and outer edges of the PCB stator board, albeit the inner and outer edges could also be plated). Referring to FIG. 9, the first layer 30, also called a “Hall” or “signal” layer, can be used to connect Hall Effect sensors (not shown) for signaling the transition of the alternating poles of the permanent magnet rotor (also not shown) and also has multiple pairs in-hand radial torque inducing conductors 34, each pair of in-hand radial conductors are electrically connected by vertically plated slots (collectively, referred to as conductors and slots 34) through and to each of the corresponding axially-parallel, two-in-hand radial torque inducing conductors of each of layers two through fourteen. Also shown on layer 30 are power terminals 31, 32, and 33, each of which are associated with a via or post. In general, there is one pad/via/post per phase, and hence, three power terminals 31, 32, 33 for a three-phase machine. Note that in FIGS. 10-13, the conductors and slots 34 are labeled as 44 (FIG. 10), 54 (FIG. 11), 64 (FIGS. 12), and 74 (FIG. 13). A common wye or star connection for the three-phase circuitry is comprised of wye terminals 35, 36, and 37. Referring to FIG. 10, the second, third, fourth and fifth layers (collectively, referred to as layers 40) are each “power” layers in that each layer has direct electrical connectivity by vias or vertical posts to a first phase power terminal 42, e.g., phase A. The entire phase A circuit is shown on layer 40 from phase power terminal 42, through end turns to each pair of in-hand radial conductors and slots 44 successively in series and ending at wye terminal 45. Layer 40 also has wye terminal 46 connecting to wye terminal 47.

The sixth, seventh, eighth and ninth layers (collectively, referred to as layers 50) shown in FIG. 11, are each “power” layers in that each layer has direct electrical connectivity by vias or vertical posts to a second phase power terminal 51, e.g., phase B. The entire phase B circuit is shown on layer 50 from phase power terminal 51, through end turns to each pair of in-hand radial conductors and slots 54 successively in series and ending at wye terminal 56. Layer 50 also has wye terminal 56 connecting to wye terminal 57.

The tenth, eleventh, twelfth and thirteenth layers (collectively, referred to as layers 60) shown in FIG. 12 are each “power” layers in that each layer has direct electrical connectivity by vias or vertical post to a third phase power terminal 63, e.g., phase C. The entire phase C circuit is shown on layer 60 from phase power terminal 63, through end turns to each pair of in-hand radial conductors and slots 64 successively in series and ending at wye terminal 67. Layer 60 also has wye terminal 65 connecting to wye terminal 66.

And the fourteenth layer 70 in FIG. 13 is a “bottom” layer, that complements the

Hall effect layer shown in FIG. 9 in that it makes the total number of layers an even number which is a manufacturing process requirement. Layer 70 has pairs of in-hand radial torque inducing conductors which radial conductors are electrically connected by vertically plated slots 74 through to each of the corresponding axially-parallel pairs of in-hand radial torque inducing conductors of each of layers first through thirteen.

As shown in FIGS. 9-13, each wye terminal is comprised of a number of plated through-holes or vias that electrically connect all layers of the wye terminals 35, 45, 55, 65 and 75; all layers of wye terminals 36, 46, 56, 66, and 76; and all layers of wye terminals 37, 47, 57, 67, and 77 of FIGS. 9-13. The wye connections for the three-phase stator connection occur between wye terminals 46 and 47 on layer 40, between wye terminals 56 and 57 on layer 50, and between wye terminals 65 and 66 on layer 60. A separate connection layer, as seen in some of the prior art, is not present in this PCB stator with improved serpentine winding. That means it is possible to create a three-phase PCB stator with improved serpentine winding is as few as three layers. Most common PCB manufacturing processes require an even number of layers; therefore, the practical minimum is four layers. The minimum number of layers in prior designs that require two distinct layers per phase to complete a three-phase stator is six.

It should be mentioned but known to those skilled in the art that between each PCB conductor layer there is an electrically insulative layer within the multilayered, axial stack of PCBs.

In one embodiment, an example method of manufacturing of the plated slot is to have a single radial torque inducing conductor copper patterned (e.g., printed or etched, such as via photolithography, chemical etching, selective plating, etc.) on a layer of the stack of PCBs, the copper patterning can be on single side or double sided PCBs, and which the single radial torque inducing conductor is connected to two in-hand outer end turns at an outer end and to two in-hand inner turn conductors at an inner end, then to mill down the length of the radial torque inducing conductor so as to form two in-hand conductors separated by the slot, and to then proceed to have the slot conductively plated (e.g., copper, copper-alloy, etc.) so as to provide for electrical connection by a vertical plated slot through to each of the corresponding axially-parallel, two-in-hand radial torque inducing conductors. Note that the manufacturing is performed using known milling and drilling equipment and is typically a very automated process. In one embodiment, to mitigate the potential of looping currents through the plated slot between the two-in-hand radial torque inducing conductors, one example method includes performing a second milling or drilling operation to remove the conductive plating (e.g., copper, copper-alloy, etc.) at either one end or both of the ends of the slot so as to not provide for electrical connectivity between the two-in-hand radial torque inducing conductors.

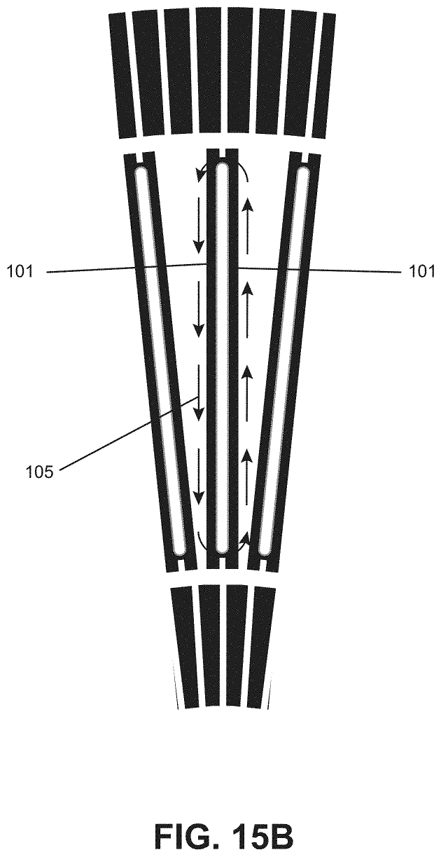

Referring now to FIGS. 14A-14C, shown are illustrations of three axial cross section views of the fourteen layered PCB. FIG. 14A is an axial cross-sectional view of a first phase, phase A, with four power layers 80 for which radial conductors connect to end turn conductors of phase A and which ten other layers 82 consist of only radial conductors which are axially electrically connected by the conductive plating 83 of the slot. FIG. 14B is an axial cross-sectional view of a second phase, phase B, with four power layers 84 for which radial conductors connect to end turn conductors of phase B and which ten other layers 86 (e.g., 86a, 86b) consist of only radial conductors which are axially electrically connected by the conductive plating 87 of slot. FIG. 14C is an axial cross-sectional view of a second phase, phase C, with four power layers 88 for which radial conductors connect to end turn conductors of phase C and which ten other layers 90 consist of only radial conductors which are axially electrically connected by the conductive plating 91 of slot.

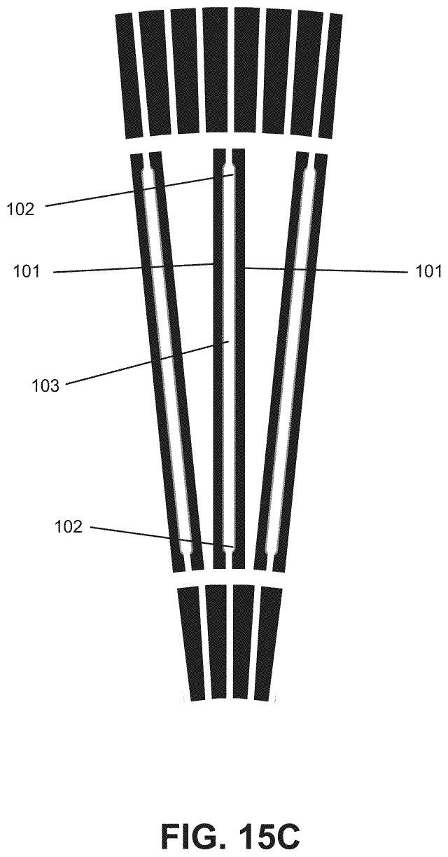

Alternatively, a slot can be milled along either side or both sides of the radial torque inducing traces of the axially stacked PCBs so as to provide for electrical connection by a vertically plated slot through to each of the corresponding axially-parallel, radial torque inducing conductors. Again, as now shown in FIGS. 15A-15C, one embodiment comprises performing a second milling or drilling operation to remove the conductive plating at either one end or both of the ends of the slot to mitigate against looping current within the plated slot by not providing for electrical connectivity between the two sides of radial torque inducing plated slot conductors. FIG. 15A is a close-up view of three radial conductors 101 as shown and described above. Conductive plating 102 covers the inner walls of the slot 103. Conductors 101 form two in-hand conductors down either side of slot 103. FIG. 15B illustrates the path of a looping current 105 which can flow between two in-hand conductors 101 due to the alternating flux from the rotating permanent magnet rotors (not shown). Such looping currents in the copper conductors are a known loss in permanent magnet air core motors. FIG. 15C has conductive plating 102 removed at the ends of slot 103. The end section of the conductive plating may be removed by a drilling or milling operation or some other means such as laser cutting.

The conductively plated slot not only provides for axial electrical connectivity to each of layer of radial conductors, but also provides for additional current carrying capacity augmenting the printed radial conductors. Also, the conductively plated conductor provides for thermal conductivity, particularly as to providing for heat transfer axially outward from the inner layers, which inner layers have greater thermal path resistance due to the multiple axial insulative layers between the radial conductors. The inner layers of a multilayer PCB usually become the thermally limiting layers, since heat that is produced in such inner layers has resistance in being removed. The conductively plated slot also provides for a conduit into which convective heat transfer can occur by having gas or liquid fluid flow in the air gap between the stator and the rotor(s) and to come into contact with the conductive plating in the slot. The convective fluid could include, but is not limited to, air or another gas or mixture of gases, or a liquid such as water, water/glycol, or a dielectric oil.

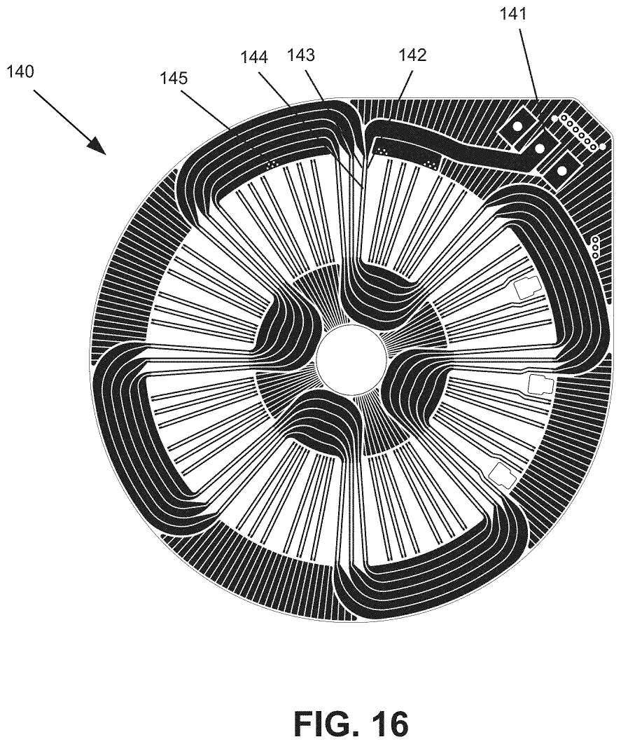

In another embodiment shown in FIG. 16, a power layer 140 for one phase (e.g. phase A) of a three-phase PCB stator has a phase power terminal 141. Power terminal 141 is electrically connected to one radial conductor 142. Radial conductor 142 is electrically connected in series with adjacent radial conductor 143. Plated slot 144 is broken at the ends by means described above to separate conductors 142 and 143. Referring back to FIG. 10, radial conductors 44 formed in-hand pairs of parallel radial conductors. The end turns of each pair of radial conductors 44 are also in parallel as shown and described. FIG. 16 shows the end turns complete the series connection to each separate radial conductor as illustrated by example conductors 142 and 143. It follows the other power layers for remaining two phases of the PCB stator will have the same series connection for the radial conductors. Wye terminals 145, 146, and 147 connect the three phases into a wye or star. This arrangement of series connected radial conductors with the plated slot axial layer to layer connection allows for a greater turn count within the same dimensions than is possible with some other PCB stator circuits. The total number of turns is limited by the circumference at the innermost end of the radial conductors. Some prior art stators use plated holes to connect layers together that are positioned along or near this circumferential line between the radial conductors and the inner end turns. PCB manufacturing tolerances require an offset from the hole diameter to the edge of the copper land or pad that contains the hole. The result is that the total number of turns is limited by the size of plated hole plus the offset plus the spacing between the pads. The improved PCB stator with serpentine winding is only limited by the width of the radial conductors plus the spacing between turns so it is possible to design a stator with many more turns.

One embodiment of a multilayer, multiphase PCB stator comprises like-phase power layers placed axially adjacent to mitigate against higher phase to phase voltage differentials that may arise when there are different phases axially adjacent to each other in the stack of a multiphase PCB stator. A further embodiment is to incorporate an insulating layer with higher voltage breakdown potential between layers that have different phase power layers then the voltage breakdown potential of the layers between like-phase power layers.

While the illustrations and narrative disclosed herein are specific to axial gap stator architectures, a similar configuration of the serpentine winding structures and methods and interconnections of like-phase conductors may be utilized for linear motors and/or radial motors and such alternate architectures of machines is contemplated by the structure and methods illustrated explicitly in detail by the axial gap machine.

The illustration and narrative disclosed herein of the in-hand wound serpentine stator is specific to a circuit architecture that provides for both polarities of terminals for each phase, e.g., a six terminal, three-phase stator. And, the illustrated PCB serpentine stator is specific to a three terminal, Star [Wye], three-phase stator. However, these examples are illustrative, and hence the invention is not limited to such specific illustrated embodiments. Instead, any number of phases, poles, turns and phase terminal arrangements can be derived by the structure and methods of the invention, including independent polarity terminals per phase, or phases connected in series, such as Star [Wye] or Delta as may be suitable for the chosen torque and speed characteristics and controllers for operation of the motor and/or generator.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein. Although the systems have been described with reference to the example embodiments illustrated in the attached figures, it is noted that equivalents may be employed, and substitutions made herein without departing from the scope of the disclosure as protected by the following claims.

1. (canceled)

2. (canceled)

3. (canceled)

4. (canceled)

5. A method, comprising:
milling and conductively plating a slot in multiple layers of printed circuit boards to provide electrical connectivity between multiple layers of parallel, torque-inducing conductors of a serpentine-patterned, multiphase stator coil.

6. The method of claim 5, further comprising a second milling step or a drilling step performed after the slot is conductively plated, wherein the second milling or drilling operation removes a portion of the plating at one or both ends of the conductively plated slot so as to break the electrical connectivity between two sides of the conductively plated slot.

7. The method of claim 5, where the radial conductors of two sides of the conductively plated slot are connected electrically in parallel.

8. The method of claim 5, where the radial conductors of two sides of the conductively plated slot are connected electrically in series.

9. (canceled)

10. (canceled)

11. (canceled)

12. A stator, comprising:
multiple layers of printed circuit boards, wherein a conductively plated slot provides for electrical connectivity between multiple layers of axially parallel, torque-inducing conductors of a serpentine-patterned, multiphase stator coil.

13. The stator of claim 12, wherein a portion of the plating at one or both ends of the conductively plated slot is omitted so as to break the electrical connectivity between two sides of the conductively plated slot.

14. The stator of claim 12, where the radial conductors of two sides of the conductively plated slot are connected electrically in parallel.

15. The stator of claim 12, where the radial conductors of two sides of the conductively plated slot are connected electrically in series.
